(19) United States
(12) Patent Application Publication
(10) Pub. No.: US 2002/0042741 A1
(43) Pub. Date: Apr. 11, 2002

(54) System, method and article of manufacture to facilitate remote station advertising

(76) Inventors: William Whiteside Wilson III, Tulsa, OK (US); Shirley Lynn Wilson, Bixby, OK (US)

Correspondence Address: Mark G. Kachigian, HEAD, JOHNSON & KACHIGIAN, 228 West 17th Place, Tulsa, OK, 74119, US

(21) Appl. No.: 09/843,263

(22) Filed: Apr. 26, 2001

Related U.S. Application Data
(60) Provisional application No. 60/200,483, filed on Apr. 28, 2000.

(51) Int. Cl. G06F 17/60

(52) U.S. Cl. 705/14

(57) ABSTRACT

A system, method and article of manufacture to facilitate the retrieval, dynamic modification and presentation of audibly and visually perceptible content at a remote station, said presentation facilitated by one or more computer compatible communication networks, content acquisition and display presentation central processing units and multiple function presentation units. Said presentation units capable of producing a plurality of variable content presentations.

### REFERENCE TO PENDING APPLICATIONS

This application is a continuation-in-part application based on Provisional Patent Application 60/200,483 filed on Apr. 28, 2000 and entitled “System, Method and Article of Manufacture To Facilitate Fuel Station Advertising”.

### REFERENCE TO MICROFICHE APPENDIX

This application is not referenced in any microfiche appendix.

### TECHNICAL FIELD OF THE INVENTION

In general, the present application relates to automated advertising displays. In particular, the present invention relates to a system, method and article of manufacture for retrieving, dynamically modifying and presenting audibly and visually perceptible content upon a remote presentation device.

### BACKGROUND OF THE INVENTION

Advertising systems and display units intended for use in remote locales are well represented in the prior art. For example:

U.S. Pat. No. 5,134,716 issued on Jul. 28, 1992 to David J. Craig, subsequently assigned to Caltex Oil Pty. Limited discloses a Point of Sale Audio-Visual Advertising System which has a central station and a plurality of outstations. The central station is generally located in a shop attached to service or filling stations which sell petroleum products such as gasoline, while the outstatations are located at self-service pumps located on the driveway of the service station. The system provides audio-visual advertising material to the purchaser while the tank filling operation is in progress and immediately prior to his entry into the shop area.

U.S. Pat. No. 5,717,374 issued on Feb. 10, 1998 to Harry F. Smith and U.S. Pat. No. 5,914,654 issued on Jun. 22, 1999 to Harry F. Smith, both subsequently assigned to Intellectual Property Development Associates of Connecticut, Inc., discloses a Methods and Apparatus For Inputting Messages, Including Advertisements, To A Vehicle. The methods and apparatus are disclosed for inputting messages and other information, such as advertisements, to a vehicle while the vehicle is coupled to a local station, such as a recharging station or a refueling station. The messages can be selected in accordance with information received from the vehicle, including information that selectively identifies one, some or all of: (a) a characteristic of an occupant of the vehicle (e.g. name, account number, address, etc.); (b) a characteristic of the vehicle (e.g. make, model, year, class, registration number, marker number, odometer reading, owner, etc.); (c) a destination of the vehicle (entered through a data entry console and optionally stored within a vehicle memory); and (d) any other characteristic of interest.

U.S. Pat. No. 5,980,090 issued on Nov. 9, 1999 to William C. Royal Jr. and Randall O. Watkins, subsequently assigned to Gilbarco, Inc., discloses an Internet Asset Management System For A Fuel Dispensing Environment. This invention provides communication servers at each device in a fueling environment and connecting the servers to a common network. The network may be a local network or a largely remote network, such as the Internet. Preferably, in either embodiment, primary communications between these devices and any devices accessible via the Internet use the hypertext transfer protocol (HTTP) and hypertext markup language (HTML). In particular, each device server is adapted to facilitate real-time access between the device server and the remote device upon access of a particular page, script or function. In particular, the present invention relates to embedding executable content onto an HTML page so that when the page is loaded into an HTML browser after being accessed, the executable content starts running automatically.

U.S. Pat. No. 6,032,126 issued on Feb. 29, 2000 to David L. Kaehler, subsequently assigned to Gilbarco, Inc., discloses an Audio and Audio/Video Operator Intercom For A Fuel Dispenser. An apparatus for installation in a retail setting for selling fuel and other products ordered by a customer interacting with an operator. A video control system interfaces an external audio/video signal source with an audio/video signal source from an other product ordering apparatus operator. The external audio/video source transmits advertising and promotional materials to a video display located on a card reader equipped fuel dispenser. Additionally, customers can signal and communicate through audio/video signals with the operator to order other merchandise. Total transaction costs for fuel and non-fuel products is provided and paid for at the fuel dispenser.

However, none of the afore cited references clearly delineate, discuss, disclose or claim a system, method or article of manufacture whereby timely geographically relevant information can be purposed and presented to specific refueling locals in conjunction with or independent of advertising content also intended for the specific local.

### BRIEF SUMMARY OF THE INVENTION

An audio/visual advertising system is disclosed which has one or more computer compatible communication networks content acquisition and display presentation central processing units, multiple function presentation units and first and second software means which allow for the retrieval and presentation of advertising and geographically relevant content.

Consequently, it is an objective of the instant invention to allow for the acquisition, dispersion and presentation of geographically relevant information to a selective receiving location within a larger universe of such locations.

It is a further objective of the instant invention to allow for the presentation of advertising media at a remote station accompanied with geographically relevant information, such as but not limited to, weather, weather alerts, sporting news, national or regional news, etc.

It is another objective of the instant invention to allow the consumer to interact with the present invention via a touch screen communications capability.

Another objective of the instant invention is to allow the consumer to interact with the present invention via an audibly receptive communications capability.

It is another objective of the instant invention to provide for the presentation of geographically relevant information and advertising media at a remote station utilizing a computer compatible communication means, such as computerized networks including terrestrial and satellite communications.

Another objective of the instant invention is to allow for a first transmission of advertising media supplemented with subsequent repeated transmissions providing updated geographically relevant information within a predetermined time interval.

Other objects and further scope of the applicability of the present invention will become apparent from the detailed description to follow, taken in conjunction with the accompanying drawings wherein like parts are designated by like reference numerals.

### DESCRIPTION OF THE DRAWINGS

FIG. 1 is a system schematic illustrating the invention's primary hardware and software processing components as practiced in its preferred embodiment.

FIG. 2 illustrates a program component which facilitates the retrieval, processing and transmitting of ticker information.

FIG. 3 illustrates the programming means steps which facilitate the processing and transmitting of image files.

FIG. 4 is a flowchart representing Phase II software functionality.

FIG. 5 is a simplified diagram denoting primary processing steps associated with data acquisition as practiced in the invention's preferred embodiment.

FIG. 6 is a simplified diagram denoting primary processing steps associated with fueling site presentation of acquired data and advertising content as practiced in the invention's preferred embodiment.

FIG. 7 is an illustrative information presentation format as practiced by the invention in its preferred embodiment.

### DETAILED DESCRIPTION OF THE PREFERRED EMBODIMENT

While the making and using of various embodiments of the present invention are discussed in detail below, it should be appreciated that the present invention provides for inventive concepts capable of being embodied in a variety of specific contexts. The specific embodiments discussed herein are merely illustrative of specific manners in which to make and use the invention and are not to be interpreted as limiting the scope of the instant invention.

The claims and the specification describe the invention presented and the terms that are employed in the claims draw their meaning from the use of such terms in the specification. The same terms employed in the prior art may be broader in meaning than specifically employed herein. Whenever there is a question between the broader definition of such terms used in the prior art and the more specific use of the terms herein, the more specific meaning is meant.

While the invention has been described with a certain degree of particularity, it is clear that many changes may be made in the details of construction and the arrangement of components without departing from the spirit and scope of this disclosure. It is understood that the invention is not limited to the embodiments set forth herein for purposes of exemplification, but is to be limited only by the scope of the attached claim or claims, including the full range of equivalency to which each element thereof is entitled.

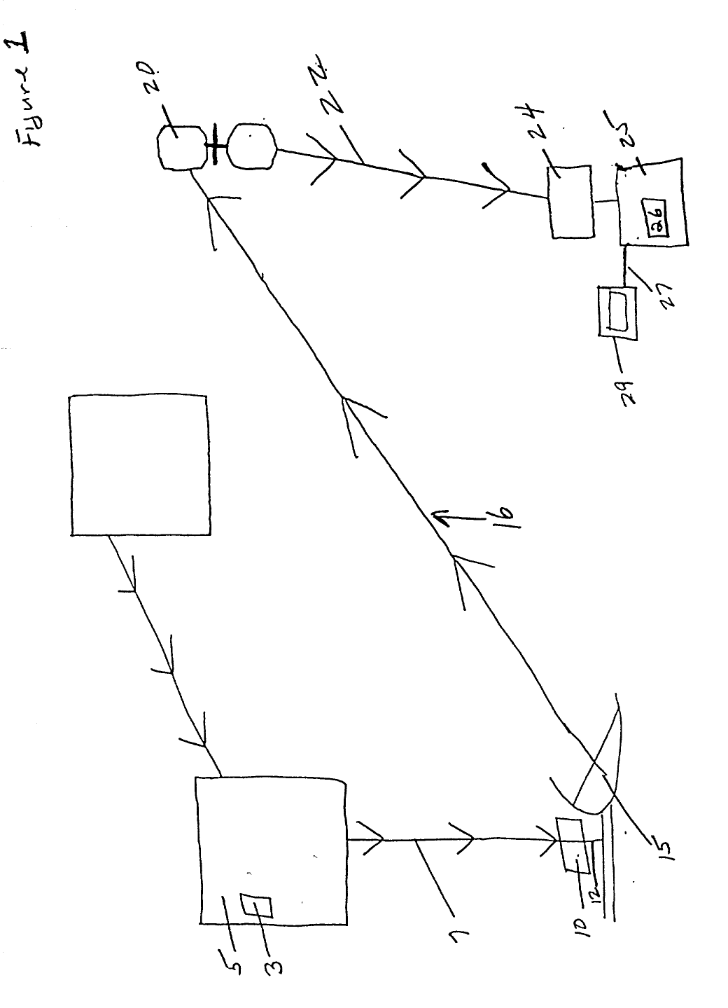

FIG. 1 is a system schematic illustrating primary hardware and software components of the instant invention as practiced in its preferred embodiment. In FIG. 1, first software 3 executing within a data acquisition central processing unit 5 facilitates the acquisition of advertising and geographically relevant data. The present invention allows for such data acquisition to be facilitated via a plurality of means. For instance, data may be presented to the data acquisition central processing unit 5, without limitation, via a transporable storage means, such as a floppy disk or computer readable recording tape commonly used to distribute advertising content or compact disk. Addititionally, said first software 3 can acquire content via a computer compatible network communication means. Examples of such computer compatible network communication means well known and practiced in the art would include, without limitation, local area networks (LAN's), wide area networks (WAN's) metropolitan area networks (MAN's), campus area networks (CAN's), Extranets, Intranets and the Internet. Content so acquired will typically be represented as geographically relevant information with multiple and diverse geographic records delineated via the insertion of a delineation code appended to a relevant record or records incorporated within an acquisition file. Said appending of said delineation code is facilitated by said first software 3. The delineated information is then compiled into a computer recognizable file structure, and stored to a storage means accessible to said data acquisition central processing unit 5. In the invention's preferred embodiment said storage means is represented and accessible as a page associated with a Web-site, though any file structure recognized by a computer based transmission protocol will facilitate practice of the invention. In the invention's preferred embodiment, File Transfer Protocol (hereinafter, referred to synonymously referred to as “FTP”) and M-PEG file structures are utilized.

Continuing with discussion relating to FIG. 1. The stored file embodying geographically delineated records is then transmitted over a communications link 7 to a transceiver facility, such as, but not limited to a satellite office central processing unit 10. Once resident and accessible to the transceiver facility 10, the transceiving facility 10 further transmits the received file to a satellite transceiver 15 over a second communications link, or hard wired connection 12 for subsequent transmission to an orbiting satellite 20, via a third communications link 16. The orbiting satellite 20 then transmits or otherwise broadcasts the delineated file to a plurality of geographically dispersed terrestrial receiving units 24, via a fourth communications link 22. Said geographically dispersed terrestrial receiving units 24 possess a receiving decoding means by which information geographically relevant to the physical location of said the ground unit 24 is decoded and presented to a remote site central processing unit 25. Such selective receipt decoding and presentation of said information would be directed towards as an example, include retail locations such as retail outlets within a specific neighborhood, town, city, state, region, or country. Said means of presenting selective content to local central processing unit(s) from a selective decoding device are well known and practiced by those skilled in the art. As an alternative communication means to facilitate the transfer of geographically relevant information and advertising media between said data acquisition central processing unit 5 and said remote site central processing unit 25, a computer compatible network such as the Internet may be used as an alternative to augment, supplement or replace the aforestated satellite base communication process. Second software 26 executing within the remote site central processing unit 25 then identifies and divides audio, video and text records contained within the transmitted file intended for received ground unit 24 and, stores such information in separate and distinct file structures accessible to said remote site central processing unit 25 and transmits said previously acquired content to an information presentation device 29. Said transmission occurring and facilitated via radio frequency (RF) transmission/receiving means 27 well known and practiced by those skilled in the art. Alternatively, said transmission may be facilitated via a hard wire/cable communication link 27 between said remote site central processing unit 25 and said information presentation device 29.

Software processes of the present invention as practiced in its preferred embodiment can best be understood as occurring in two distinct phases. Phase I (a.k.a “first software”) 3, executed within a data acquisition central processing unit 5, and Phase II (a.k.a. “second software”) 26, executed from within a remote site central processing unit 25 . Phase I of source code for said first software is immediately included herein for purposes of providing full and enabling disclosure.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

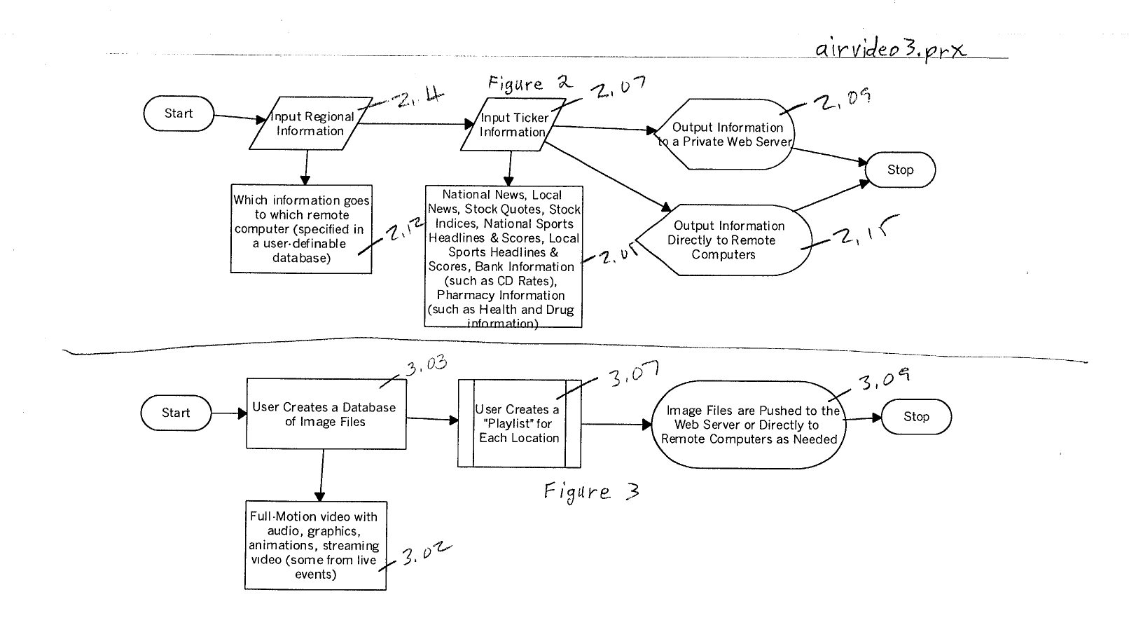

FIGS. 2 and 3 are flow charts illustrating the software functionality of Phase I software ticker and image processing components (a.k.a. ticker and image components, respectively). In the invention's preferred embodiment, said Phase I software operates in a Windows® environment, however the invention's programming logic is neither platform specific nor dependent.

The data acquisition central processing unit can utilize a dial-up connection, but normally functions with a high-speed Internet connection and can communicate directly with the remote site central processing units, or can upload information via FTP, HTTP, or HTTPS protocols.

FIG. 2 illustrates a software processing component which facilitates the retrieval, processing, and transmitting of “Ticker” information. Such information represents a variety of viewer-essential information including, but not limited to, current national news headlines, local news headlines, national and local sports headlines, national and local sports scores, stock quotes, stock market indices and news 2.05.

The Phase I processing component is capable of retrieving and inputting 2.07 information from the Internet, virtual private network (VPN), or direct modem connection and can be customized for an individual client. For example, if the client is a bank the ticker could retrieve current CD rates and other client-specific information.

The data acquisition central processing unit contains a database which segregates remote site central processing units by assigning each group and sub-group codes 2.04. Such codes can be assigned based upon geographic or other criteria 2.12 and this processing component allows for complete user-definable groups and sub-groups.

These codes are utilized to determine information to be sent to each remote computer. For example, each or every remote computer within a metropolitan area may be sent local news and weather information specific to that area 2.12.

Once ticker information for each remote computer has been generated 2.07, 2.08, it is transmitted either directly to the remote computer (via direct modem connection, VPN, or FTP) 2.15 or is transmitted to a private web server 2.05. A web server acts as a repository of information which is continually updated and available for the remote site central processing units to download.

FIG. 3 illustrates the program processing means steps which facilitate the processing and transmitting of image files. The invention's image files consist of, but are not limited to, full-motion video (FMV), graphics, animations, and streaming video. Audio is also a component of these file types and can be integrated into the file itself or can be a separate file played (executed) in synchronization with the image file.

Non-limiting examples of the invention's image files include, but are not limited to, corporate commercials, public service ads, current weather graphics (retrieved from the Internet or other means on a continuing basis), local and national sports team schedules, National Weather Service advisories and warnings, traffic flow information, or fugitive information 3.02.

Image and audio files can be obtained from clients, user-generated, or retrieved from the Internet. Once obtained, these files are stored in an indexed database 3.03 on the data acquisition central processing unit (or on a computer accessible via network connection to the data acquisition central processing unit).

In FIG. 3, the user next creates “playlists” on the data acquisition central processing unit 3.07. These “playlists” consist of indexed references to image files, audio files, and ticker information. The “playlists” are designed and designated for groups, sub-groups, or individual remote site central processing units 3.07.

The Phase I image processing component processes these “playlists” as they are entered by the user and maintains an inventory (database) of file names located on each remote computer. When a “playlist” is created by the user, the program determines which remote site central processing units are to be included. The processing component then compares the “playlist” with the file names of the addressed remote site central processing units.

If files required to execute the “playlist” are not on a particular remote computer, then the appropriate files are transmitted directly to the remote computer or they are transmitted to a private web server 3.09. The “playlists” are also transmitted to the specified remote site central processing units.

Once a “playlist” is entered, the processing component ensures that requested files are available to the data acquisition central processing unit. If they are not, an error message is generated, and the user is prompted to download the necessary files to the data acquisition central processing unit (or to a computer residing on the same network as the data acquisition central processing unit).

The Phase I image processing component also contains sub-routines designed to detect problematic occurrences at the transmitting site. These occurrences may be, but are not limited to, a faulty Internet connection, a loss of feedback from a remote computer, or a failure of one of the other programs running on the computer.

When problems are detected the program can send notification of these occurrences to an appropriate service technician. These notifications can be in the form of, but are not limited to, visual screen notification, e-mails, a transmission to a private web server, or a signal sent to a pager. The data acquisition central processing unit is designed with several redundant systems. First and foremost is a fully-functional computer which contains a program to verify the functionality of the data acquisition central processing unit. If any problems are detected, a secondary computer will begin operations and take over all of the ticker and image processing component transmission functions.

Several redundancies are in place for the private web server. Should the server fail for any reason, another private web server will be automatically chosen and utilized in its stead.

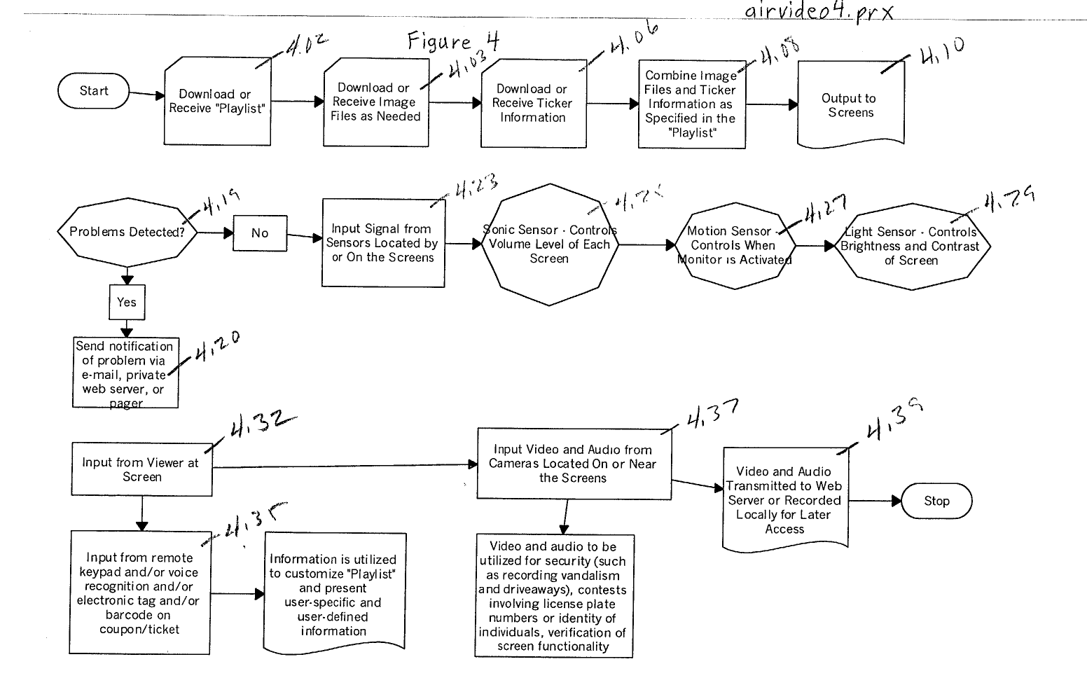

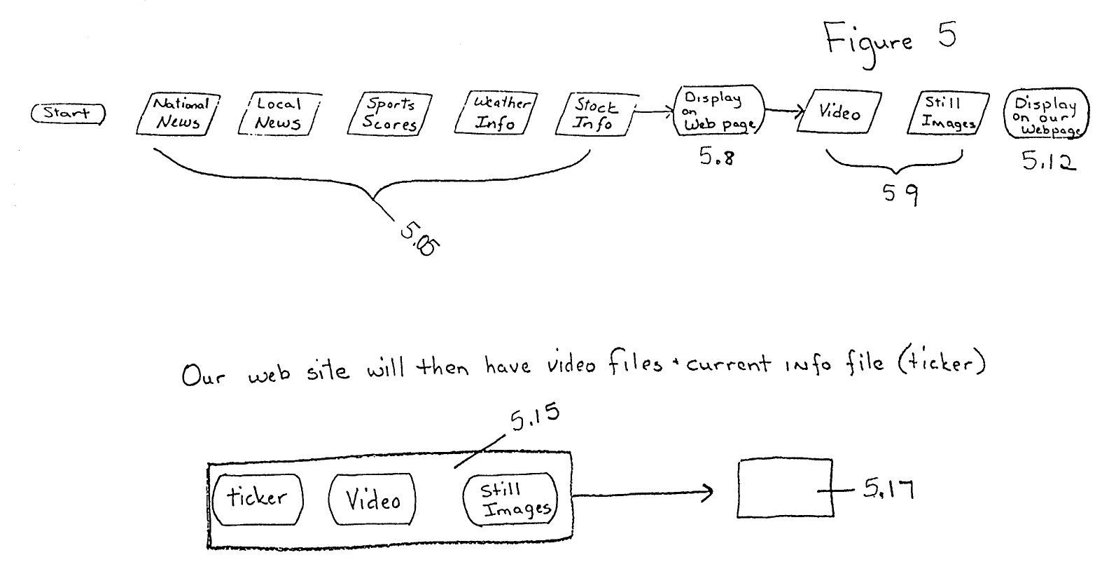

FIG. 4 is a flow chart representing Phase II software functionality. The remote site central processing units are currently operating in a Windows® environment, but the programming is not platform specific. Phase II software source code is immediately provided to facilitate purposes of full and enabling invention disclosure.

′This form will not be visible. It will be running on the remote computer
′at the store locations
Private Sub Receive()
′Open Internet Web Site and Download New Data for Ticker
′Open Internet Web Site and Download and Changes to Video Segments
′Open Satellite Files from Satellite Receiver (both data and video)
End Sub
Private Sub Transmit()
′Transmit video feed to monitors on pumps.
′Transmit ticker to bottom portion of monitors on pumps.
′Ticker information will come from the data stream
′and will contain national news, sports scores, dow jones
′industrial avg., nasdaq avg., s&p500 avg., local news,
′local weather
End Sub
VERSION 5.00
Begin VB.Form frmDataEnv

Caption = ″MediaVision Internet and Satellite Receiving″
ClientHeight = 3195
ClientLeft = 60
ClientTop = 345
ClientWidth = 4680
LinkTopic = ″Form1″
ScaleHeight = 11115
ScaleWidth = 15240
StartUpPosition = 3 ′Windows Default

End
VERSION 5.00
Begin {C0E45035-5775-11D0-B388-00A0C9055D8E} DataEnvironment1

ClientHeight = 5055
ClientLeft = 1080
ClientTop = 1500
ClientWidth = 6300
_ExtentX = 11113
_ExtentY = 8916
FolderFlags = 3
TypeLibGuid = ″{A5DC9AF5-9235-11D1-B067-00DD01144174}″
TypeInfoGuid = ″{A5DC9AF6-9235-11D1-B067-00DD01144174}″
TypeInfoCookie = 0
Version = 4
NumConnections = 1
BeginProperty Connection1

ConnectionName = ″Connection 1″
ConnDispId = 1001
SourceOfData = 3
QuoteChar = 34
SeparatorChar = 46

EndProperty
NumRecordsets = 0

End
VERSION 5.00
Begin {78E93846-85FD-11D0-8487-00A0C90DC8A9} DataReport1

Caption = ″DataReport1″
ClientHeight = 8235
ClientLeft = 1650
ClientTop = 1545
ClientWidth = 6585
_ExtentX = 11615
_ExtentY = 14526
_Version = 393216
_Designer Version = 100684101
BeginProperty Font {0BE35203-8F91-11CE-9DE3-00AA004BB851}

Name = ″Arial″
Size = 8.25
Charset = 0
Weight = 400
Underline = 0 ′False
Italic = 0 ′False
Strikethrough = 0 ′False

EndProperty
GridX = 10
GridY = 10
LeftMargin = 1440
RightMargin = 1440
TopMargin = 1440
BottomMargin = 1440
NumSections = 3
SectionCode0 = 2
BeginProperty Section0 {1C13A8E0-A0B6-11D0-848E-00A0C90DC8A9}

_Version = 393216
Name = ″Section2″
Object.Height = 360
NumControls = 0

EndProperty
SectionCode1 = 4
BeginProperty Section1 {1C13A8E0-A0B6-11D0-848E-00A0C90DC8A9}

_Version = 393216
Name = ″Section1″
Object.Height = 1440
NumControls = 0
EndProperty
SectionCode2 = 7
BeginProperty Section2 {1C13A8E0-A0B6-11D0-848E-00A0C90DC8A9}
_Version = 393216
Name = ″Section3″
Object.Height = 360
NumControls = 0

EndProperty

End
′sending a video file and ticker to monitors
Private Sub MMControll GotFocus()
′MMControll.Command = ′Open″
′MMControll.PlayVisible = True
′MMControll.PlayEnabled = True
′MMControll.Command = ″Play″
′MMControll.Visible False
End Sub
Private Sub MediaPlayer1_DVDNotify(ByVal EventCode As Long, ByVal EventParam1
As Long, ByVal EventParam2 As Long)
′This will play a video file taking up the majority of the screen as defined on the form
MediaPlayer1.FileName = ″c:\windows\desktop\video1.mpg″
MediaPlayer1.Open
MediaPlayer1.Stop
End Sub
Private Sub Ticker()
′Open data file containing raw text for ticker
′format data
′send to monitors
End Sub
VERSION 5.00
Object = ″(22D6F304-B0F6-11D0-94AB-0080C74C7E95)#1.0#0″;″MSDXM.OCX″
Begin VB.Form Form1

Caption = ″Form1″
ClientHeight = 3195
ClientLeft = 60
ClientTop = 345
ClientWidth = 4680
LinkTopic = ″Form1″
ScaleHeight = 11115
Scale Width = 15240
StartUpPosition = 3 ′Windows Default
WindowState = 2 ′Maximized

Begin MediaPlayerCtl.MediaPlayer MediaPlayer1

Height = 10575
Left = 240
TabIndex = 0
Top = 120
Width = 14895
AudioStream = −1
AutoSize = 0 ′False
AutoStart = −1 ′True
AnimationAtStart = −1 ′True
AllowScan = −1 ′True
AllowChangeDisplaySize = −1 ′True
AutoRewind = 0 ′False
Balance = 0
BaseURL = ″″
BufferingTime = 5
CaptioningID = ″″
ClickToPlay = −1 ′True
CursorType = 0
CurrentPosition = −1
CurrentMarker = 0
DefaultFrame = ″″
DisplayBackColor = 0
DisplayForeColor = 16777215
DisplayMode = 0
DisplaySize = 3
Enabled = −1 ′True
EnableContextMenu = −1 ′True
EnablePositionControls = −1 ′True
EnableFullScreenControls = 0 ′False
EnableTracker = −1 ′True
Filename = ″c:\windows\desktop\video 6.mpg″
InvokeURLs = −1 ′True
Language = −1
Mute = 0 ′False
PlayCount = 999
PreviewMode = 0 ′False
Rate = 1
SAMILang = ″″
SAMIStyle = ″″
SAMIFileName = ″″
SelectionStart = −1
SelectionEnd = −1
SendOpenStateChangeEvents = −1 ′True
SendWarningEvents = −1 ′True
SendErrorEvents = −1 ′True
SendKeyboardEvents = 0 ′False
SendMouseClickEvents = 0 ′False
SendMouseMoveEvents = 0 ′False
SendPlayStateChangeEvents = −1 ′True
ShowCaptioning = 0 ′False
ShowControls = 0 ′False
ShowAudioControls = −1 ′True
ShowDisplay = 0 ′False
ShowGotoBar = 0 ′False
ShowPositionControls = −1 ′True
ShowStatusBar = 0 ′False
ShowTracker = −1 ′True
TransparentAtStart = 0 ′False
VideoBorderWidth = 0
VideoBorderColor = 0
VideoBorder3D = 0 ′False
Volume = −600
WindowlessVideo = 0 ′False

End

End

The remote site central processing units can utilize a dial-up connection or a high-speed Internet connection. The computer can communicate directly with the data acquisition central processing unit via modem or VPN. It can also download information via FTP, HTTP, or HTTPS protocols from the private web server on the Internet.

The remote site central processing units download the “playlists” designated for their receipt 4.02. If a direct link is established with the data acquisition central processing unit, then the necessary files (image, audio, ticker information) are also received 4.03.

If there is no direct link with the data acquisition central processing unit, then the “playlist” is analyzed by the program. If the “playlist” refers to files which the remote computer does not have on its hard disk, then the files are downloaded from the private web server.

The ticker information is downloaded 4.06 or received very frequently (usually every five to ten minutes). This facilitates the timely refreshing of news and other time-critical information to the viewer.

All downloaded files are stored on the remote computer's hard drive 4.08. Audio and video files are archived when not being used, but the ticker information is usually overwritten as newer information is obtained.

The computer combines the ticker information with the image and audio files according to the “playlist”. A video and audio signal are created with this combined information. This signal is sent to video monitors via a hard wire or RF signal as indicated in the hardware description 4.10.

The ticker information is normally contained within a horizontal strip at the bottom of the monitor's viewable screen area. However, the ticker can be placed at the top or in a vertical alignment. The remainder of the screen is filled with the appropriate video signal corresponding to the “playlist”.

The program also contains sub-routines designed to detect problematic occurrences at the remote site 4.19. These occurrences may be, but are not limited to, a faulty Internet connection, a loss of video or audio at a video screen, or a failure of one of the other programs running on the computer.

When problems are detected the program can send notification of these occurrences to the appropriate service technician 4.20. These notifications can be in the form of, but are not limited to, e-mails, a transmission to a private web server, or a signal sent to a pager.

In some instances, the screens may have sensors located on or near them. These sensors include, but are not limited to, sonic, motion, or light. The sensors are software-controlled via a communications port hub 4.23.

The sonic sensor measures the decibel level at each screen location. This information is used by the program to control the audio volume which is sent to that screen 4.25.

The motion sensor detects when a vehicle (or a user-defined object) has approached the screen 4.27. This information is used by the program to determine when the screen is active or passive. The light sensor measures the radiance level at each screen location. This information is used by the program to control the brightness and contrast of each screen 4.29.

The program is designed to allow for input from the viewer 4.32 (or user in this instance) at each screen location. This input can be from, but is not limited to, a remote keypad, a voice recognition system facilitated by a microphone, a receiver designed to detect electronic signatures, an optical scanner, or a barcode reader.

The keypad can be numeric or alpha-numeric 4.35. The data received by the remote computer from the keypad can be utilized to respond to user queries, or to accumulate and display information based upon user preferences.

A voice recognition system can be composed of a wide-area microphone at the screen location. The microphone signal would be processed by a sound board or a specialized speech-recognition card located within the computer. This signal is interpreted via a combination of hardware and software technology. The data received by the remote computer from the voice recognition technology can be utilized to respond to user queries, or to recognize voice signatures which correspond to customizable user profiles.

An electronic signature can be detected by a receiver located at each screen location. These electronic signatures can be generated by an RF device, or other user-specific electronic transmitting mechanism. The electronic signature would be unique to each user and would identify that user to the remote computer. Once identified, commercials or other information can be tailored specifically for that individual based upon their profile.

An optical scanner or a barcode reader can be utilized to identify specific users and customize information based upon their profile. An optical scanner or a barcode reader can also be used for the purpose of reading coupons, “tickets”, or other company-generated written instruments. For example, a contest could be created and “tickets” printed up. The “ticket” could be identified by the optical scanner or the barcode reader, and the user notified as to whether or not they are a winner. Video and video/audio cameras can be located at each screen or facing towards each screen 4.37. The signals from each camera can be wired through a video control box first or they can be wired directly into a multi-function digital capture card in the computer. The signals are segregated so that the program is aware of each individual video signal.

These video/audio captures can be either time-lapsed or full-motion (up to 30 frames per second, or fps). The captured digital images and sound can be stored locally on the remote computer, streamed to another computer, or they can be transmitted to a private web server for later retrieval by an employee or designated client 4.39.

The video and audio can be used for many purposes, including but not limited to, security, contests, or verification of screen functionality.

When the audio/video is utilized as a security mechanism, the uses are many-fold. The video/audio can be used to identify vehicles which drive away from the pump without paying. It can be used to identify individuals who commit vandalism. It can be used to identify robbery suspects, or persons attempting to harm the employees of a client.

The audio/video digital recording can also be used to identify vehicle tag numbers, which can later be used to pick out the winner of a contest. This recording of vehicle tag numbers is also an effective method of locating those who drive away from the pump without paying (driveaways). A very important aspect of the video/audio recording is the ability to detect and trouble-shoot any problems with the screens. These cameras ensure that the screens are projecting an image when they should be. If there is a problem, it can be easily determined which screens are malfunctioning so that a service technician can be dispatched to make any needed hardware repairs.

Finally, the cameras at or near the screens act as a deterrent to unlawful behavior. They reduce the incidence of driveaways, and possibly even the number of robbery and vandalism attempts at a client's location.

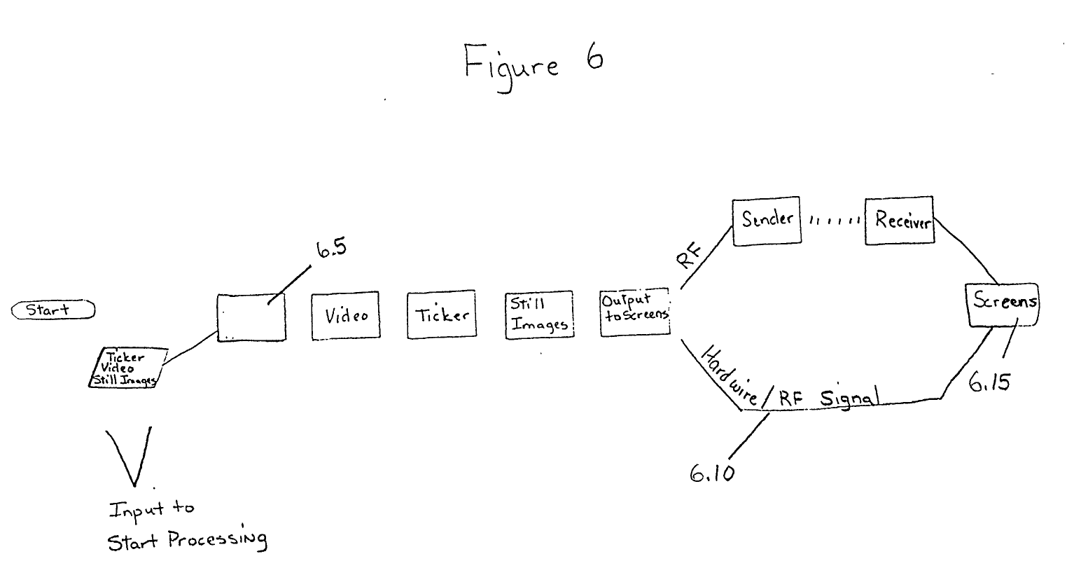

FIG. 5 illustrates high level Phase I software 3 processes executing within the data acquisition central processing unit 5, accessing and collecting via a network communication means a diverse plurality of geographically relevant information 5.05. Said collated information is then displayed on a computer resident and accessible storage medium, such as a web page 5.8. Accompanying video and still images 5.9 are provided as further records and also displayed on said accessible storage medium 5.12. This information is then combined 5.15 and is communicated via a computer recognizable and compatible communication means via a transfer protocol such as FTP to a transceiver facility 5.17 for subsequent processing by Phase II components of the instant invention. Phase II components of the information are disclosed in association with FIG. 6.

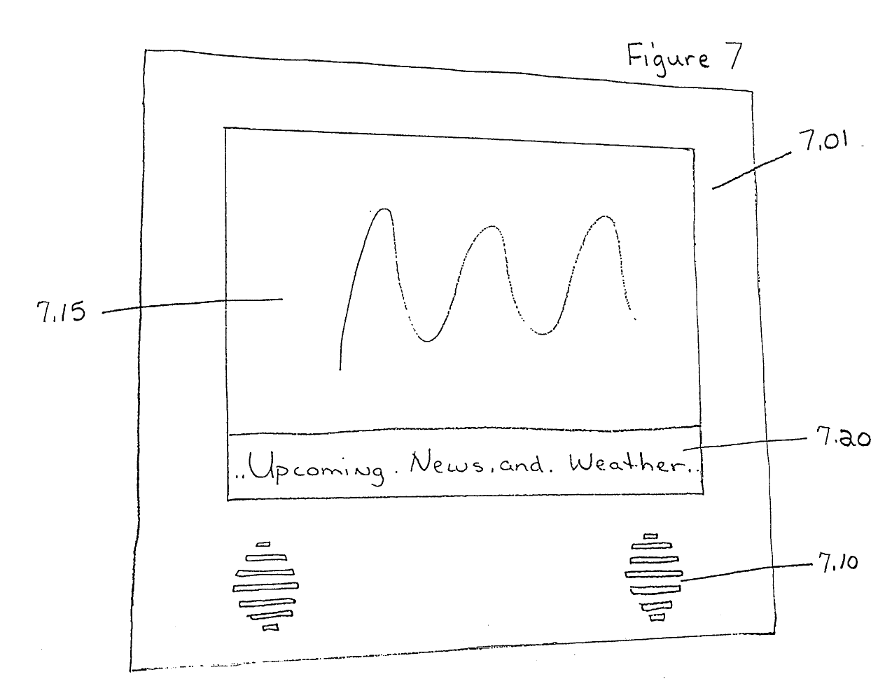

FIG. 6 illustrates Phase II of the instant invention wherein the combined ticker, video, still image file is transmitted to multiple geographically dispersed remote receiving locations. As each segment (a.k.a. “record”) of ticker, video and still image records contain delineation control code inserted via first software processing, only codes matching those of geographically relevant locations within a geographically dispersed area will receive and be able to decode such information. Consequently, only information for an individual remote station, group of stations, located within a neighborhood, city, town, country, etc. will receive coded information. Such coded information is then processed by software resident at the store location 6.5 and further transmitted via either RF signal or hard wire to screens 6.10 or information presentation devices 6.15 approximate to fuel pump gassing apparatuses. Such features of the display apparatuses are shown in conjunction with FIG. 7.

In FIG. 7 a display device 7.01 is presented. The screen display area is broken into two general areas. A display area for photographs or images 7.15 and a display area for textural images 7.20, 7.10 designates speaker areas for audio content accompanying said display images or files.

While this invention has been described to illustrative embodiments, this description is not to be construed in a limiting sense. Various modifications and combinations of the illustrative embodiments as well as other embodiments will be apparent to those skilled in the art upon referencing this disclosure. It is therefore intended that this disclosure encompass any such modifications or embodiments.

### Alternate Embodiments

The foregoing description, for purposes of explanation, used specific nomenclature to provide a thorough understanding of the invention. However, it will be apparent to one skilled in the art that the specific details are not required in order to practice the invention. In other instances, well known circuits and devices are shown in block diagram form in order to avoid unnecessary distraction from the underlying invention. Thus, the foregoing descriptions of specific embodiments of the present invention are presented for purposes of illustration and description. They are not intended to be exhaustive or to limit the invention to the precise forms disclosed, obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

Further, the method and system described herein above is amenable for execution on various types of executable mediums others than a memory device such as a random access memory. Other types of executable mediums can be used, such as but not limited to, a computer readable storage medium which can be any memory device, compact disc, or floppy disk.

What is claimed is:

1. An audiovisual presentation system to retrieve, dynamically modify and present geographically relevant content to one or more discernible receiving locations within a larger universe of such locations based on specified user criteria, said system comprising:
at least one data acquisition general purpose computer comprising a central processing unit and at least one video display unit and at least one input device communicably attached to said central processing unit, said video display and input device configured to facilitate user interaction with said central processing unit;
at least one data acquisition database in communication with said central processing unit, video display and input device, said database permitting said user to interactively store and manipulate said geographically relevant data based upon said criteria;
first data acquisition and manipulation software residing and executing within said data acquisition central processing unit to analyze said database based upon said criteria specified by the user via said video display and input devices, said software execution yielding geographically relevant and encoded audio and visual content;
at least one receiving site general purpose computer comprising a central processing unit and at least one video display unit and at least one input device communicably attached to said central processing unit, said video display and input device configured to facilitate user interaction with said receiving site central processing unit;
at least one receiving site content database in communication with said receiving site central processing unit, video display and input device, said database permitting said remote user to interactively store and manipulate geographically relevant data;
a least one decoding means communicably attached to said data acquisition and said receiving site general purpose computers, said decoding means facilitating the acquisition of geographically relevant encoded information intended for presentation to computer compatible audio and visual devices communicably attached to said receiving site general purpose computer;
second data acquisition and manipulation software residing and executing within said receiving site central processing unit to analyze said acquired geographically relevant information, said second data acquisition and manipulation software execution yielding a customized presentation of geographically relevant audio, visual and text content upon computer compatible audio and visual devices communicably attached to said receiving site general purpose computer.

2. The system as recited in claim 1 wherein said data acquisition and said receiving site general purpose computers, are communicably attached via a computer compatible communications network.

3. The system as recited in claim 1 wherein said input devices are computer keyboards or computer mouses and said video displays are computer monitors.

4. The system as recited in claim 1 wherein said presented geographically relevant content is visually perceptible text data.

5. The system as recited in claim 1 wherein said presented geographically relevant content is audibly perceptible information.

6. The system as recited in claim 1 wherein said presented geographically relevant content is motion video content.

7. The system as recited in claim 1 wherein said presented geographically relevant content is a combined media presentation, said combined media selected from a group including audibly perceptible information, motion video content and visually perceptible text data.

8. An audiovisual presentation method to retrieve, dynamically modify and present geographically relevant content to one or discernible receiving locations within a larger universe of such locations based on specified user criteria, said method comprising:
determining the scope and source of geographically relevant information to be acquired via a computer compatible communications network;
communicating said scope and source of geographically relevant information to be acquired to a first data acquisition and manipulation software means as data acquisition determinants;
executing said first data acquisition and manipulation software to acquire said geographically relevant information based upon said communicated data acquisition determinants;
associating a encoded remote location identifier with acquired geographically relevant information to facilitate selective reception of said acquired geographically relevant information at one or more distinctly addressable remote locations within a larger universe of such locations;
transmitting said encoded remote location identifier with said acquired geographically relevant information to at least one receiving site general purpose computer via a computer compatible communications network;
analyzing and manipulating via second data acquisition and manipulation software said transmitted encoded remote location identifier and said acquired geographically relevant information, said second software analysis and manipulation yielding a customized presentation of geographically relevant audio, visual and text content upon at least one computer compatible audio device and one computer compatible visual display device communicably attached to said receiving site general purpose central processing.

9. The method of claim 8 wherein said transmitting of encoded remote location identifier and said acquired geographically relevant information to at least one receiving site general purpose computer is facilitated via the Internet.

10. The method of claim 8 wherein said transmitting of encoded remote location identifier and said acquired geographically relevant information to at least one receiving site general purpose computer is facilitated via at least one satellite communication link and wherein said transmitted identifier and information is first received by a satellite communication decoding means communicably attached to said receiving site general purpose computer.

11. The method of claim 8 wherein said transmitting of encoded remote location identifier and said acquired geographically relevant information to at least one receiving site general purpose computer is facilitated via the Internet and at least one satellite communications link.

12. The method of claim 8 wherein said analyzing and manipulating via second data acquisition and manipulation software further includes integrating remotely stored receiving site content with said transmitted encoded remote location identifier and said acquired geographically relevant information to yield a customized presentation of geographically relevant audio, visual and text content upon at least one computer compatible audio device and computer compatible visual display device communicably attached to said receiving site general purpose central processing unit.

13. The method of claim 8 further comprising the steps of:
scheduling the presentation of audio and visual content to said computer compatible audio and computer compatible visual display devices communicably attached to said receiving site general purpose central processing unit.

14. A computer readable medium encoded with a computer program for retrieving, dynamically modifying and presenting geographically relevant content to one or discernible receiving locations within a larger universe of such locations based on specified user criteria, said method comprising collaboratively determining optimal space utilization comprising:
a code segment for receiving determinants defining the scope and source of geographically relevant information to be acquired via a computer compatible communications network;
a code segment for acquiring said geographically relevant information based upon said communicated data acquisition determinants;
a code segment for encoding a remote location identifier with acquired geographically relevant information to facilitate selective reception of said acquired geographically relevant information at one or more distinctly addressable remote locations within a larger universe of such locations; and
a code segment for transmitting said encoded remote location identifier with said acquired geographically relevant information to at least one receiving site general purpose computer via a computer compatible communications network.

15. The computer program of claim 14 wherein said code segment for transmitting encoded remote location identifier and acquired geographically relevant information to at least one receiving site general purpose computer further comprises initiating such transmission via the Internet.

16. The computer program of claim 14 wherein said code segment for transmitting encoded remote location identifier and acquired geographically relevant information to at least one receiving site general purpose computer further comprises initiating such transmission via the Internet and at least one satellite communication link.

17. A computer readable medium encoded with a computer program for analyzing and manipulating encoded remote location identifier and geographically relevant information comprising:
a code segment for analyzing and manipulating said remote location identifier and geographically relevant information, said analysis and manipulation yielding a customized presentation of geographically relevant audio and visual content upon at least one computer compatible audio and one computer compatible visual display device communicably attached to a receiving site general purpose central processing unit.

18. The program of claim 17 wherein said code segment for analyzing and manipulating further comprises integrating remotely stored receiving site content with said transmitted encoded remote location identifier and said acquired geographically relevant information to yield a customized presentation of geographically relevant audio and visual content upon at least one computer compatible audio and computer compatible visual display device communicably attached to said receiving site general purpose central processing unit.
